(19) United States
(12) Patent Application Publication
(10) Pub. No.: US 2025/0249895 A1
(43) Pub. Date: Aug. 7, 2025

(54) VEHICLE CONTROL DEVICE

(71) Applicant: TOYOTA JIDOSHA KABUSHIKI KAISHA, Toyota-shi (JP)

(72) Inventor: Yuta HIRAIWA, Miyoshi-shi (JP)

(73) Assignee: TOYOTA JIDOSHA KABUSHIKI KAISHA, Toyota-shi (JP)

(21) Appl. No.: 18/931,293

(22) Filed: Oct. 30, 2024

(30) Foreign Application Priority Data
Feb. 1, 2024 (JP) 2024-014377

(51) Int. Cl. B60W 30/09; B60W 30/095; B60W 50/00

(52) U.S. Cl. CPC B60W 30/09; B60W 30/0956; B60W 50/0097; B60W 2520/10; B60W 2554/802

(57) ABSTRACT

The vehicle control device is configured such that the contact risk determination condition is relaxed when a first condition for determining that a road on which the own vehicle is traveling is a narrow road, an oncoming vehicle approaching the own vehicle and a second condition for determining that a moving body moving at a low speed exists between the oncoming vehicle and the own vehicle within the predetermined range, a third condition for determining that the oncoming vehicle is highly likely to reach a rear end of the moving body before the own vehicle reaches a front end of the moving body, and a fourth predetermined condition regarding a relative motion between the oncoming vehicle and the moving body are satisfied.

### CROSS-REFERENCE TO RELATED APPLICATION

This application claims priority to Japanese Patent Application No. 2024-014377 filed on Feb. 1, 2024, incorporated herein by reference in its entirety.

### BACKGROUND

### 1. Technical Field

The disclosure relates to a vehicle control device that starts a risk reduction control for controlling an own vehicle such that a risk of contact between the own vehicle and a target (a probability of contact between the own vehicle and the target, or damage caused when the two come into contact) is reduced when a predetermined condition is satisfied.

### 2. Description of Related Art

In a situation in which a width of a road on which the own vehicle and an oncoming vehicle are traveling is relatively small, there are cases in which a condition for determining that the risk of contact between the own vehicle and the oncoming vehicle is high will be satisfied. In this case, a vehicle control device that starts a risk reduction control for controlling the own vehicle such that the contact risk is reduced has been proposed (e.g., see WO 2014/027420). The vehicle control device according to WO 2014/027420 (hereinafter, referred to as “conventional device”) is capable of executing, as risk reduction control, notification control issued by a predetermined alarm to a driver of the own vehicle, braking control for braking the own vehicle, and automatic steering control for steering the own vehicle such that the own vehicle moves away from the oncoming vehicle.

### SUMMARY

Now, a scenario can be envisioned in which a moving body that is moving at a low speed is present in a section ahead of the oncoming vehicle (a region between the oncoming vehicle and the own vehicle) on a narrow road, and in this state, the oncoming vehicle overtakes the moving body. In this scenario, the width of the road on which the own vehicle and the oncoming vehicle are traveling is relatively small, and accordingly the likelihood of the oncoming vehicle making a significant movement into a region ahead of the own vehicle when the oncoming vehicle overtakes the moving body, is high. In this case, the likelihood that it will be difficult to steer the own vehicle to miss the oncoming vehicle is high. Accordingly, in a scenario in which the oncoming vehicle overtakes the moving body on a narrow road, it is preferable that braking of the own vehicle is started as early as possible (e.g., before the oncoming vehicle starts to overtake the moving body).

Now, in the conventional device, a start condition of the risk reduction control is configured to be satisfied when time, obtained by dividing a distance between the own vehicle and the oncoming vehicle by a relative speed, is no greater than a threshold value. That is to say, the start condition of the risk reduction control is unrelated to behavior of the oncoming vehicle or the moving body. Hence, the conventional device cannot adjust a start timing of the risk reduction control in accordance with the height of the likelihood that the oncoming vehicle will overtake the moving body on the narrow road. As a result, there are cases in which the start condition is satisfied after the oncoming vehicle starts to overtake the moving body. In this case, there is concern that effects of executing the risk reduction control (the effect of reducing the risk of contact between the own vehicle and the oncoming vehicle) will be scant.

An object of the disclosure is to provide a vehicle control device capable of controlling an own vehicle such that the risk of contact between an oncoming vehicle and the own vehicle will be sufficiently reduced when the likelihood that the oncoming vehicle overtaking a moving body ahead thereof on a narrow road is high.

In order to solve the above problem, a vehicle control device (1) according to the disclosure executes risk reduction control for controlling an own vehicle so as to reduce a contact risk when a contact risk determination condition, that is a condition for determining that the contact risk between a target that is present within a predetermined range in a traveling direction of the own vehicle and the own vehicle is high, is satisfied. The vehicle control device is configured such that when satisfying
a first condition for determining that a road on which the own vehicle is traveling is a narrow road,
a second condition for determining that an oncoming vehicle approaching the own vehicle, and a moving body moving at a low speed between the oncoming vehicle and the own vehicle, are present within the predetermined range,
third condition for determining that a likelihood of the oncoming vehicle reaching a rear end of the moving body before the own vehicle reaches a front end of the moving body is high, and
a predetermined fourth condition relating to relative movement of the oncoming vehicle and the moving body,
the contact risk determination condition is relaxed.

In the vehicle control device according to an aspect of the disclosure, the fourth condition is satisfied in a situation in which a speed difference between the oncoming vehicle and the moving body exceeds a predetermined first threshold value and also an acceleration of the oncoming vehicle exceeds a second threshold value, or in a situation in which the speed difference is no greater than the first threshold value and also the acceleration of the oncoming vehicle exceeds a predetermined third threshold value.

In the vehicle control device according to another aspect of the disclosure, the contact risk determination condition is satisfied when a predicted time until the own vehicle and the oncoming vehicle come into contact with each other is no greater than a fourth threshold value,
a value assigned to the fourth threshold value is decided in accordance with a relative speed between the own vehicle and the oncoming vehicle,
when at least one of the first condition to the fourth condition is not satisfied, and also the relative speed is a first speed, a first predetermined value is assigned to the fourth threshold value, and
when the first condition to the fourth condition are satisfied, and also the relative speed is a second speed that is lower than the first speed, a second predetermined value that is greater than the first predetermined value is assigned to the fourth threshold value.

In the vehicle control device according to another aspect of the disclosure, the contact risk determination condition is satisfied when a predicted time until the own vehicle and the oncoming vehicle come into contact with each other is no greater than a fourth threshold value,
a value assigned to the fourth threshold value is decided in accordance with an overlap rate that is a degree of overlap between a region where the own vehicle is predicted to pass and a region where the oncoming vehicle is predicted to pass,
when at least one of the first condition to the fourth condition is not satisfied, and also the overlap rate is a first overlap rate, a first predetermined value is assigned to the fourth threshold value, and
when the first condition to the fourth condition are satisfied, and also the overlap rate is a second overlap rate smaller than the first overlap rate, a second predetermined value greater than the first predetermined value is assigned to the fourth threshold value.

In the vehicle control device according to another aspect of the disclosure, when a distance between the moving body and the own vehicle is no greater than a predetermined fifth threshold value, a vehicle speed of the own vehicle is limited to be no greater than a predetermined upper limit value.

As described above, in the vehicle control device according to the present disclosure, when the first condition to the fourth condition are satisfied, determination is made that the oncoming vehicle is highly likely to overtake the moving body on the narrow road, and the start condition (contact risk determination condition) of the risk reduction process is relaxed. That is to say, an execution start timing of the risk reduction control is advanced in this scenario. Accordingly, the risk of contact between the own vehicle and the oncoming vehicle is sufficiently reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a vehicle control device according to an embodiment of the present disclosure;

FIG. 2 is a plan view showing an overlap rate;

FIG. 3 is a plan view showing a scene in which an oncoming vehicle is highly likely to overtake a moving body on a narrow road; and

FIG. 4 is a flow chart of a program executed by CPU to realize the functions of the vehicle control device.

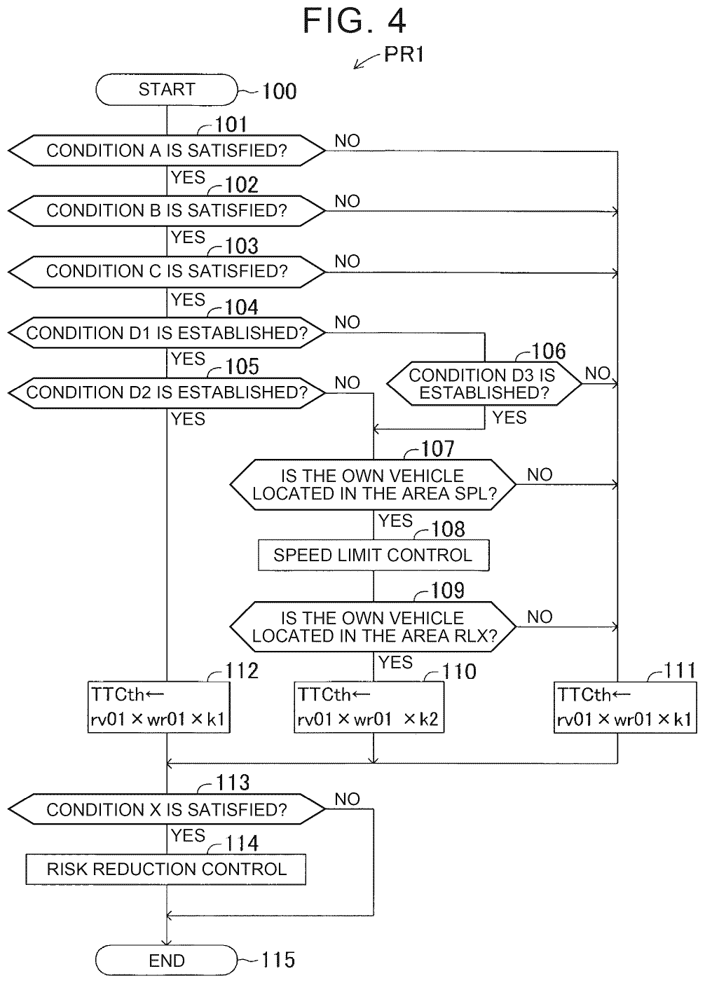

### DETAILED DESCRIPTION OF EMBODIMENTS

### Overview

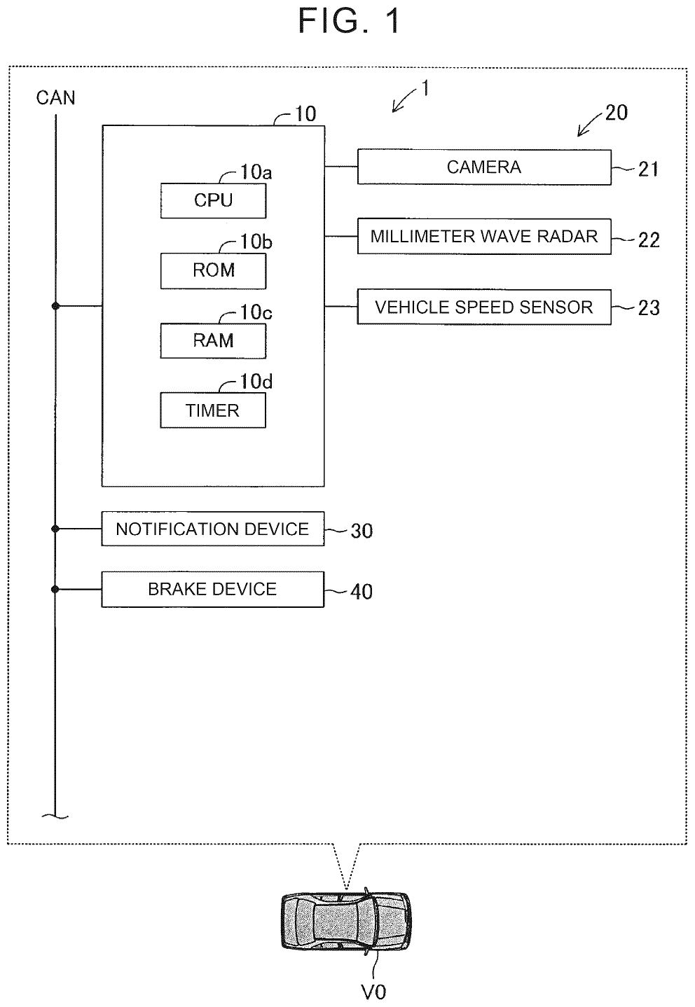

As illustrated in FIG. 1, a vehicle control device 1 according to an embodiment of the present disclosure is applied to a vehicle V0 having an automated driving function (hereinafter, referred to as an “own vehicle”). The vehicle control device 1 includes a function (risk reduction function) that executes risk reduction control for controlling the own vehicle (the notification device 30 and the braking device 40) so that the risk of contacting the own vehicle with the oncoming vehicle V1 is reduced while the autonomous 10 driving function is disabled.

### Specific Configuration

As illustrated in FIG. 1, the vehicle control device 1 includes a ECU 10, an in-vehicle sensor 20, a notification device 30, and a braking device 40.

ECU 10 include CPU 10a, ROM 10b, RAM 10c, timer 10d, etc. ECU 10 is connected to another ECU via a CAN.

The in-vehicle sensor 20 includes a camera 21 and a millimeter wave radar 22.

The camera 21 includes an imaging device and an image analysis device. The imaging device incorporates, for example, a CCD. The imaging device is installed at a front portion of the own vehicle and is directed toward the front of the own vehicle. The imaging device captures a foreground of the own vehicle at a predetermined frame rate, and acquires a foreground image (image data). The image analysis device analyzes the foreground image and recognizes (identifies) a target object existing within the angle of view of the imaging device. For example, the image analysis apparatus recognizes a vehicle such as a normal vehicle or a truck. Further, the image analysis device recognizes a moving body such as a pedestrian or a bicycle. That is, the image recognition apparatus can distinguish the vehicle from the moving body. Further, the image analysis device recognizes lane marks (division lines of the road R, guard rails, and the like) in the foreground image, and acquires lane mark information including coordinates of lane marks, extension directions, and the like in the image. The image-analysis device provides these computations to ECU 10.

The millimeter wave radar 22 includes a transmission/reception unit and a signal processing unit. The transmission and reception unit radiates a millimeter-wave band radio wave (hereinafter, referred to as “millimeter wave”) toward the front of the own vehicle, and receives a millimeter wave (reflected wave) reflected by a three-dimensional object located in the region. The signal processing unit acquires various kinds of information on each reflection point of the millimeter wave based on the physical quantity related to the radiation wave and the reflected wave. For example, the signal processing unit calculates the position (relative position (distance and direction)) of each reflection point with respect to the own vehicle. In addition, the signal processing unit calculates the speed of each reflection point with respect to the own vehicle (the change (relative speed) of the distance between the own vehicle and the reflection point per unit time). Then, the calculation result (distribution data (data including the relative position and the relative velocity) of the reflection point) is provided to ECU 10.

The imageable range of the camera 21 and the region where the millimeter waves of the millimeter wave radar 22 are radiated overlap. In the following explanation, a region where both are overlapped is referred to as a field of view FOV of the target detection sensor DS. In plan view, the field of view FOV is fan-shaped. ECU 10 can acquire the information based on the fusion information obtained by integrating the information obtained from the camera 21 and the information obtained from the millimeter wave radar 22. The information includes information on targets (types of targets (vehicles, moving bodies, and the like), positions (relative positions) of targets with respect to the own vehicle, and speeds (relative speeds (vectors)) of targets with respect to the own vehicle) existing in the field of view FOV.

The in-vehicle sensor 20 further includes a vehicle speed sensor 23. The vehicle speed sensor 23 acquires the speed sp0 (speed (scalar) with respect to the road R) of the own vehicle based on the rotational speed of the wheels per unit time. Then, the vehicle speed sensor 23 provides the speed sp0 to ECU 10.

The notification device 30 includes an image display device and an acoustic device. The image display device displays an image in accordance with an image display command acquired from ECU 10. The sound device reproduces the sound in accordance with the sound reproduction command acquired from ECU 10.

The braking device 40 applies a braking force to the wheels. The braking device 40 includes a brake caliper, a brake ECU, and the like. The brake ECU controls the brake caliper based on a command (a target value of a braking force (deceleration)) acquired from another ECU. As a result, the own vehicle is braked.

### Risk Reduction Function

When the ignition switch of the own vehicle is in the on-state, ECU 10 sequentially acquires various kinds of information from the in-vehicle sensor 20, and executes various kinds of calculation based on the information. Specifically, ECU 10 detects a target OB located in the field of view FOV based on the fusion data. Then, ECU 10 predicts a time TTC until the own vehicle and the target OB touch each other. Specifically, ECU 10 acquires the distance ΔD between the own vehicle and the target OB and the relative velocity rv that is the velocity of the target OB with respect to the own vehicle. ECU 10 obtains a value obtained by dividing the distance ΔD by the relative-velocity rv as a predicted time TTC. ECU 10 determines that the risk of contact between the own vehicle and the target OB is high when the condition X below is satisfied, and executes risk reduction control for controlling the own vehicle so that the risk of contact is reduced. The condition X is referred to as a “contact risk determination condition”, a “start condition of risk reduction control”, or the like.

[Conditional X]. The predicted time TTC is less than or equal to the threshold value TTCth (TTC≤TTCth). ECU 10 can execute notification control and automated braking control as risk reduction control.

### Notification Control

ECU 10 displays, to the driver, an icon indicating that there is a high-risk touch with the target OB, and transmits a command to reproduce the alarm sound to the notification device 30.

### Automatic Braking Control

ECU 10 transmits a command for decelerating the own vehicle (target value of deceleration) to the braking device 40.

Here, the threshold value TTCth is not a fixed value, but a value corresponding to the situation is assigned to the threshold value TTCth as described below. ECU 10 performs the following operations to decide what to assign to the threshold values TTCth.

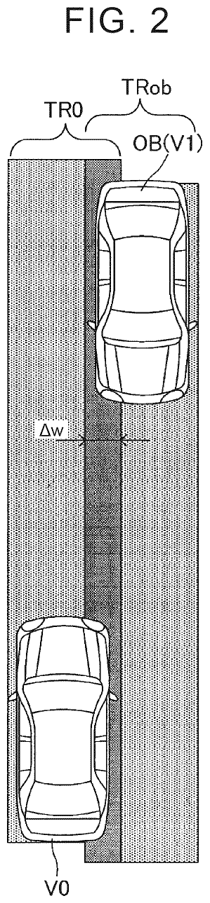

As shown in FIG. 2, ECU 10 calculates a predicted trajectory TRO which is a region predicted to pass through the own vehicle, and a predicted trajectory TRob which is a region predicted to pass through the target OB (the oncoming vehicle V1 in the example of FIG. 2).

Specifically, ECU 10 acquires the orientation dir0 of the own vehicle with respect to the road R based on the lane mark data. Further, ECU 10 acquires the speed sp0 from the vehicle speed sensor 23. ECU 10 acquires the speed sp0 and the orientation dir0 as a velocity v0 (vector) of the own vehicle with respect to the road R. ECU 10 acquires a trajectory of the own vehicle within the latest predetermined period based on a change in the speed v0 (time-series data of the speed v acquired within the latest predetermined period), and acquires a band-shaped region in which the trajectory is extended forward as the predicted trajectory TRO. ECU 10 may acquire the predicted trajectory TRO based on information acquired from a steering angle sensor, a yaw rate sensor, or the like (not shown) in addition to the lane mark information.

Further, ECU 10 executes a vector operation of subtracting the speed v0 of the own vehicle from the relative speed rv of the own vehicle and the target OB, thereby acquiring the speed vob of the target object OB (speed (speed, direction) of the target object OB with respect to the road R). ECU 10 obtains the predicted trajectory TRob based on the change in the velocity vob. The bandwidth of the predicted trajectory TRO is equal to the vehicle width of the own vehicle, and the bandwidth of the predicted trajectory TRob is equal to the width of the target OB.

ECU 10 acquires, as the overlap rate wr, a value obtained by dividing the width Δw of the portion where the predicted trajectory TRO and the predicted trajectory TRob overlap by the vehicle width of the own vehicle. When the width Δw of the portion where the predicted trajectory TRO and the predicted trajectory TRob overlap is not constant (when both trajectories are not parallel), the value obtained by dividing the largest value of the width Δw by the vehicle width of the own vehicle is acquired as the overlap rate wr.

ECU 10 decides a value to be assigned to the threshold value TTCth according to the relative-velocity rv and the overlap rate wr. ECU 10 assigns a larger value to the threshold value TTCth as the relative-velocity rv increases. That is, the start timing of the risk reduction control is accelerated. In addition, ECU 10 assigns a larger value to the threshold value TTCth as the overlap rate wr increases. That is, the larger the overlap rate wr is, the earlier the starting timing of the risk reduction control is. For example, ECU 10 assigns to the threshold values TTCth the values obtained according to the following arithmetic expression (1) defined using the coefficients k1, the relative-velocity rv and the overlap rate wr.

$$TTCth = rv \times wr \times k 1 \qquad ( 1 )$$

ECU 10 may acquire a value corresponding to the current relative speed rv and the overlap rate wr by referring to a map (not shown) defining the relation between the “relative speed rv and the overlap rate wr” and the “value assigned to the threshold value TTCth”.

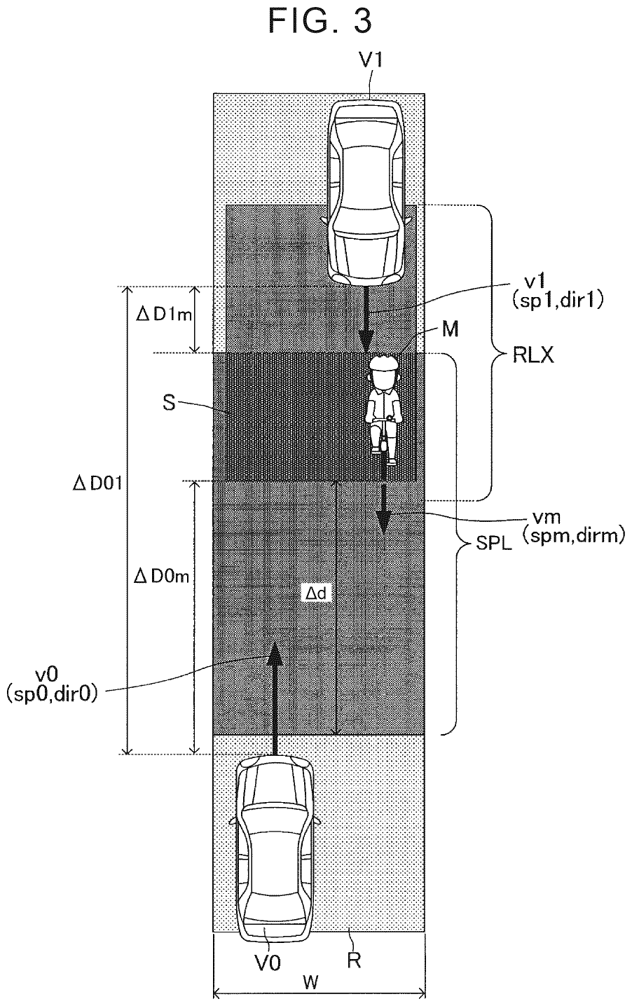

Incidentally, as shown in FIG. 3, it is assumed that the oncoming vehicle V1 overtakes the moving body M moving at a low speed on a narrow road. In a narrow road, it is likely that it is difficult to steer the own vehicle to avoid the oncoming vehicle V1. Therefore, in this scene (particularly, a scene in which the oncoming vehicle V1 exceeds the moving body M even though the own vehicle and the oncoming vehicle V1 are in close proximity to each other), it is preferable to brake the own vehicle as early as possible.

Therefore, when the oncoming vehicle V1 is highly likely to overtake the moving body M on a narrow road, ECU 10 reduces the risk of contacting the oncoming vehicle V1 with the own vehicle as described below.

Specifically, ECU 10 sequentially executes a process (scene-determination process) of determining whether or not “the own vehicle, the oncoming vehicle V1, and the moving body M (hereinafter, referred to as the “own vehicle or the like”) are traveling on a narrow road and the oncoming vehicle V1 is highly likely to overtake the moving body M in front of the own vehicle”. The scene determination process includes the following first to fourth processes.

### First Treatment

The first process is a process of determining whether the road R on which the own vehicle or the like is traveling is a narrow road (narrow road determination process). ECU 10 acquires the width W of the road R based on the lane mark information (the distance between the pair of left and right lane marks in the foreground image). ECU 10 determines that the road R is a narrow road when the following condition A is satisfied.

[Conditional A] . . . . Width W is less than or equal to the threshold Wth.
The threshold Wth is, for example, about “2.5 times” the vehicle width of the own vehicle. In addition, ECU 10 may acquire the width W from the map information of the navigation system (not shown). In addition, ECU 10 may determine that the road R is a narrow road when there is no centerline.

### Second Treatment

When the condition A is satisfied, ECU 10 executes the second process. The second process includes an oncoming vehicle detection process and a moving body detection process.

### Oncoming Vehicle Detection Processing

The oncoming vehicle detection process is a process of determining the presence or absence of the oncoming vehicle V1. ECU 10 may detect the presence of the vehicle in front of the own vehicle based on the fusion data. In this case, ECU 10 acquires the speed v1 (the speed sp1 and the direction dir1) of the vehicle based on the relative speed vr01 of the vehicle with respect to the own vehicle and the speed v0 of the own vehicle. ECU determines that an oncoming vehicle V1 exists when the condition B1 below is satisfied.

[Condition B1]. The speed sp1 exceeds the threshold sp1th and the orientation dir1 is within the predetermined angular range θ1 of the own vehicle (sp1>sp1th, dir1=01).

### Moving Body Detection Processing

The moving body detection process is a process of determining the presence or absence of the moving body M (low-speed moving body). ECU 10 may detect that a moving body (a pedestrian, a bicycle, or the like) exists between the own vehicle and the oncoming vehicle V1 in a section in front of the oncoming vehicle V1 based on the fusion information. In this case, ECU 10 acquires the speed vm (the speed spm, direction dirm) of the moving body based on the relative speed vrm of the moving body with respect to the own vehicle and the speed v0 of the own vehicle. ECU 10 determines that the moving body M is present when the following condition B is satisfied.

[Conditional B2]. The speed spm is greater than “0” and is less than or equal to the threshold spmth, and the orientation dirm is within a predetermined angular range θm opposite to the orientation dir0 of the own vehicle. (0<spm≤spmth, dirm∈θm)
ECU 10 determines that the condition B is satisfied when the condition B1 and the condition B2 are satisfied.

### Third Treatment

ECU 10 executes the third process when the condition B is satisfied. The third process is a process of determining the success or failure of the condition C regarding the positional relationship of the own vehicle or the like. The third processing includes the following first proximity determination processing, first arrival determination processing, and second proximity determination processing.

### First Proximity Determination Process

The first proximity determination process is a process of determining whether the own vehicle and the oncoming vehicle V1 are in close proximity. ECU 10 acquires a distance ΔD01 between the own vehicle and the oncoming vehicle V1 based on the fusion information. ECU 10 determines that the own vehicle and the oncoming vehicle V1 are close to each other when the condition C1 below is satisfied.

[Condition C1]. The distance ΔD01 is less than or equal to the threshold ΔD01th (AD01≤ ΔD01th).

### First Arrival Determination Processing

The first arrival determination process is a process of determining whether or not the oncoming vehicle V1 is likely to reach the rear end of the moving body M before the own vehicle reaches the front end of the moving body M. ECU 10 acquires a time Δt0m until the own vehicle reaches the front end of the moving body M based on the distance ΔD0m between the own vehicle and the moving body M and the relative velocity rv0m between the own vehicle and the moving body M. Further, ECU 10 acquires a time Δt1m until the oncoming vehicle V1 reaches the rear end of the moving body M based on the distance ΔD1m between the oncoming vehicle V1 and the moving body M and the relative velocity rv1m between the oncoming vehicle V1 and the moving body M. ECU 10 determines that the oncoming vehicle V1 is likely to reach the rear end of the moving body M before the own vehicle reaches the front end of the moving body M when the condition C2 below is satisfied.

[Condition C2]. The time Δt1m is equal to or less than the value obtained by adding the predetermined margin Δt to the time Δt0m (Δt1m≤Δt0m+Δt).
When the condition C2 is not satisfied, ECU 10 determines that there is a high possibility that the own vehicle passes through the side of the moving body M before the oncoming vehicle V1, and therefore there is a low possibility that the oncoming vehicle V1 overtakes the moving body M in front of the own vehicle. In a simple manner, ECU 10 may determine that the condition C2 is satisfied when the distance ΔD1m is smaller than the distance ΔD0m.

### Second Proximity Determination Process

The second proximity determination process is a process of determining whether the oncoming vehicle V1 and the moving body M are close to each other. ECU 10 acquires a distance ΔD1m between the oncoming vehicle V1 and the moving body M based on the fusion information. ECU 10 determines that the own vehicle and the oncoming vehicle V1 are close to each other when the condition C3 below is satisfied.

[Condition C3]. The distance ΔD1m is less than or equal to the threshold ΔD1mth (ΔD1m≤ΔD1mth).

When the condition C1 to the condition C3 are satisfied, ECU 10 determines that the condition C is satisfied.

### Fourth Treatment

ECU 10 executes the fourth process when the condition C is satisfied. The fourth process is a process of determining the success or failure of the condition D relating to the velocity relation (motion) of the oncoming vehicle V1 and the moving body M. The third processing includes speed difference determination processing, deceleration determination processing, and acceleration determination processing described below.

### Speed Difference Determination Processing

The speed difference determination process is a process of determining whether or not the speed difference Asp between the oncoming vehicle V1 and the moving body M is large to some extent (whether or not the driver of the oncoming vehicle V1 is large enough to be regarded as having an intention to overtake the moving body M). ECU 10 (the speed difference Asp between the oncoming vehicle V1 and the moving body M=sp1-spm) determines that the speed difference Asp is large to some extent when the following condition D1 is satisfied.

[Condition D1]. The velocity difference Asp exceeds the threshold Δspth (sp1-spm>Δspth).

Here, even if the velocity difference Asp is large to some extent, if the oncoming vehicle V1 is decelerating, it is unlikely that the oncoming vehicle V1 will overtake the moving body M. On the other hand, even if the velocity difference Asp is not so large, if the oncoming vehicle V1 is accelerating, there is a possibility that the oncoming vehicle V1 overtakes the moving body M. Therefore, ECU 10 executes the deceleration determination process or the acceleration determination process described below according to the success or failure of the condition D1.

### Deceleration Determination Processing

The deceleration determination process is a process of determining whether the oncoming vehicle V1 is decelerating. ECU 10 executes the deceleration determination process when the condition D1 is satisfied. ECU 10 acquires an acceleration a1 (acceleration with respect to the road R) of the oncoming vehicle V1 based on a change in the speed sp1 of the oncoming vehicle V1 (time-series data of the speed sp1 within the latest predetermined time). ECU 10 determines that the oncoming vehicle V1 is decelerating when the condition D2 below is satisfied.

[Condition D2]. The acceleration a1 is less than or equal to the negative threshold na1th (a1≤na1th).

### Acceleration Determination Processing

The deceleration determination process is a process of determining whether the oncoming vehicle V1 is accelerating. ECU 10 executes the acceleration determination process when the condition D1 is not satisfied. ECU 10 determines that the oncoming vehicle V1 is accelerating when the condition D3 below is satisfied.

[Condition D3] . . . . The acceleration a1 exceeds the positive threshold pa1th (a1>pa1th).

ECU 10 determines that the condition D is satisfied when the condition D1 is satisfied and the condition D2 is not satisfied (when the velocity difference Asp is large to some extent and the oncoming vehicle V1 is not decelerated). Further, ECU 10 determines that the condition D is satisfied when the condition D1 is not satisfied and the condition D3 is satisfied (when the velocity difference Asp is not so large but the oncoming vehicle V1 is accelerating).

When the condition A to the condition D are satisfied, ECU 10 determines that “the own vehicle, the oncoming vehicle V1, and the moving body M are traveling on a narrow road, and the oncoming vehicle V1 is highly likely to overtake the moving body M in front of the own vehicle”. In this case, as shown in FIG. 3, ECU 10 determines, in the vicinity of the oncoming vehicle V1, a predetermined area RLX, a threshold value TTCth based on the following arithmetic expression (2) in place of the arithmetic expression (1) in order to decide a high degree of contact-risk between the own vehicle and the oncoming vehicle V1. That is, the relative speed vr and the overlap rate wr of the arithmetic expression (2) are substituted with the relative speed rv01 between the own vehicle and the oncoming vehicle V1 and the overlap rate wr01 between the own vehicle and the oncoming vehicle V1.

$$TTCth = rv \times wr \times k 2 \qquad ( 2 )$$

Here, the coefficient k2 of the arithmetic expression (2) is larger than the coefficient k1 of the arithmetic expression (1). Therefore, TTCth of thresholds in the case where the arithmetic expression (2) is used is larger than in the case where the arithmetic expression (1) is used. That is, in the area RLX, a condition for starting the risk reduction control (a condition for determining that the touch risk is higher) is relaxed. The area RLX has a rectangular shape extending in the longitudinal direction of the road R in a plan view. The width of the area RLX is equal to the width W of the road R. One end and the other end in the longitudinal direction of the area RLX are located in the vicinity of the windshield of the oncoming vehicle V1 and in the vicinity of the front end of the moving body M, respectively. ECU 10 may decide TTCth by referring to a map (not shown).

### Speed Limit Control

In addition, when the conditions A to D are satisfied, the execution of the speed limit control described below is permitted. Specifically, ECU 10 controls the braking device 40 so that the speed sp0 of the own vehicle becomes equal to or lower than the upper limit sp0th in the area SPL in the vicinity of the moving body M. Here, the area SPL has a rectangular shape extending in the longitudinal direction of the road R in a plan view, and a part of the rectangular shape overlaps the area RLX. The width of the area SPL is equal to the width of the road R. One end and the other end in the longitudinal direction of the area SPL are located near the front end of the oncoming vehicle V1 and forward in the traveling direction of the moving body M, respectively. A distance Δd between the other end and the front end of the moving body M is set to a predetermined value Δdth. That is, when the distance ΔD0m between the own vehicle and the moving body M is equal to or smaller than the predetermined value Δdth, ECU 10 executes the speed-limiting control. It should be noted that the deceleration of the own vehicle by the speed limit control is slower than the deceleration of the own vehicle by the automatic braking control. In the region S where the area RLX and the area SPL overlap each other, if the condition X is not satisfied, the speed limit control is executed, and the notification control and the automatic braking control are not executed. On the other hand, in the region S, when the condition X is satisfied, the notification control and the automatic braking control are executed, and the speed limit control (slow deceleration) is not executed.

Next, referring to FIG. 5, a program PR1 executed by a CPU 10a (hereinafter simply referred to as “CPU”) of ECU 10 in order to realize the above-described functions of the vehicle control device 1 will be described.

### Program PR1

CPU starts executing the program PR1 at a predetermined cycle. CPU starts executing the program PR1 from step 100, and advances the process to step 101.

In step 101, CPU determines whether the condition-A is successful. If CPU determines that the condition A is satisfied (101: Yes), the process proceeds to step 102. On the other hand, if it is not determined that the condition A is satisfied (101: No), CPU advances the process to step 111, which will be described later.

In step 102, CPU determines whether the condition-B is successful. If it is determined that the condition B is satisfied (102: Yes), CPU proceeds to step 103. On the other hand, if it is not determined that the condition B is satisfied (102: No), CPU advances the process to step 111 to be described later.

In step 103, CPU determines whether the condition C is successful. If CPU determines that the condition C is satisfied (103: Yes), the process proceeds to step 104. On the other hand, if it is not determined that the condition C is satisfied (103: No), CPU advances the process to step 111 to be described later.

In step 104, CPU determines whether the condition D1 is successful. If CPU determines that the condition D1 is satisfied (104: Yes), the process proceeds to step 105. On the other hand, if it is not determined that the condition D1 is satisfied (104: No), CPU advances the process to step 106 to be described later.

In step 105, CPU determines whether the condition D2 is successful. If CPU determines that the condition D2 is satisfied (105: Yes), the process proceeds to step 112, which will be described later. On the other hand, if it is not determined that the condition D2 is satisfied (105: No), CPU advances the process to step 107 to be described later.

In step 106, CPU determines whether the condition D3 is successful. If CPU determines that the condition D3 is satisfied (106: Yes), the process proceeds to step 107. On the other hand, if it is not determined that the condition D3 is satisfied (106: No), CPU advances the process to step 107 to be described later.

In step 107, CPU determines whether the own vehicle is located in the area SPL. If CPU determines that the own vehicle is located in the area SPL (107: Yes), the process proceeds to step 108. On the other hand, if CPU does not determine that the own vehicle is located in the area SPL (107: No), the process proceeds to step 111.

CPU performs speed-limiting control at step 108. That is, CPU transmits a deceleration command to the braking device 40 so that the speed sp0 of the own vehicle becomes equal to or lower than the upper limit sp0th. CPU then proceeds to step 109.

In step 109, CPU determines whether the own vehicle is located in the area RLX. If CPU determines that the own vehicle is located in the area RLX (109: Yes), the process proceeds to step 110. On the other hand, if CPU does not determine that the own vehicle is located in the area RLX (109: No), the process proceeds to step 111.

In step 110, CPU assigns the values obtained according to the arithmetic expression (2) to the threshold values TTCth. CPU then proceeds to step 113.

In step 111, CPU assigns the values obtained according to the arithmetic expression (1) to the threshold values TTCth. CPU then proceeds to step 113. In step 112, CPU executes the same process as in step 111.

In step 113, CPU determines whether the condition X is successful. If CPU determines that the condition X is satisfied (113: Yes), the process proceeds to step 114. On the other hand, if it is not determined that the condition X is satisfied (113: No), CPU advances the process to step 115.

CPU performs risk reduction control at step 114. Then, ECU 10 advances the process to step 115, and ends executing the program PR1 in step 115.

### Effect

When the condition A to the condition D are satisfied, the vehicle control device 1 determines that the oncoming vehicle V1 is highly likely to overtake the moving body M on the narrow road, and relaxes the condition X as the starting condition of the risk reduction control. That is to say, an execution start timing of the risk reduction control is advanced in this scenario. Accordingly, the risk of contact between the own vehicle and the oncoming vehicle is sufficiently reduced.

### Modification

Among the functions of the vehicle control device 1, the function of executing the speed limit control may be omitted.

What is claimed is:

1. A vehicle control device for executing risk reduction control for controlling an own vehicle so as to reduce a contact risk when a contact risk determination condition, that is a condition for determining that the contact risk between a target that is present within a predetermined range in a traveling direction of the own vehicle and the own vehicle is high, is satisfied, wherein the vehicle control device is configured such that when satisfying
a first condition for determining that a road on which the own vehicle is traveling is a narrow road,
a second condition for determining that an oncoming vehicle approaching the own vehicle, and a moving body moving at a low speed between the oncoming vehicle and the own vehicle, are present within the predetermined range,
a third condition for determining that a likelihood of the oncoming vehicle reaching a rear end of the moving body before the own vehicle reaches a front end of the moving body is high, and
a predetermined fourth condition relating to relative movement of the oncoming vehicle and the moving body,
the contact risk determination condition is relaxed.

2. The vehicle control device according to claim 1, wherein the vehicle control device is configured such that the fourth condition is satisfied in a situation in which a speed difference between the oncoming vehicle and the moving body exceeds a predetermined first threshold value and also an acceleration of the oncoming vehicle exceeds a second threshold value, or in a situation in which the speed difference is no greater than the first threshold value and also the acceleration of the oncoming vehicle exceeds a predetermined third threshold value.

3. The vehicle control device according to claim 1, wherein the vehicle control device is configured such that
the contact risk determination condition is satisfied when a predicted time until the own vehicle and the oncoming vehicle come into contact with each other is no greater than a fourth threshold value,
a value assigned to the fourth threshold value is decided in accordance with a relative speed between the own vehicle and the oncoming vehicle,
when at least one of the first condition to the fourth condition is not satisfied, and also the relative speed is a first speed, a first predetermined value is assigned to the fourth threshold value, and
when the first condition to the fourth condition are satisfied, and also the relative speed is a second speed that is lower than the first speed, a second predetermined value that is greater than the first predetermined value is assigned to the fourth threshold value.

4. The vehicle control device according to claim 1, wherein the vehicle control device is configured such that
the contact risk determination condition is satisfied when a predicted time until the own vehicle and the oncoming vehicle come into contact with each other is no greater than a fourth threshold value,
a value assigned to the fourth threshold value is decided in accordance with an overlap rate that is a degree of overlap between a region where the own vehicle is predicted to pass and a region where the oncoming vehicle is predicted to pass,
when at least one of the first condition to the fourth condition is not satisfied, and also the overlap rate is a first overlap rate, a first predetermined value is assigned to the fourth threshold value, and
when the first condition to the fourth condition are satisfied, and also the overlap rate is a second overlap rate smaller than the first overlap rate, a second predetermined value greater than the first predetermined value is assigned to the fourth threshold value.

5. The vehicle control device according to claim 1, wherein the vehicle control device is configured such that when a distance between the moving body and the own vehicle is no greater than a predetermined fifth threshold value, a vehicle speed of the own vehicle is limited to be no greater than a predetermined upper limit value.
